(19) United States
(12) Patent Application Publication
(10) Pub. No.: US 2023/0316734 A1
(43) Pub. Date: Oct. 5, 2023

(54) POSE FUSION ESTIMATION

(71) Applicant: Honda Motor Co., Ltd., Tokyo (JP)

(72) Inventors: Daksh DHINGRA, Seattle, WA (US); Nawid JAMALI, Dublin, CA (US); Snehal DIKHALE, San Jose, CA (US); Karankumar PATEL, San Jose, CA (US); Soshi IBA, Mountain View, CA (US)

(21) Appl. No.: 17/710,922

(22) Filed: Mar. 31, 2022

(51) Int. Cl. G06V 10/80; G06T 7/10; G06V 10/82; G06V 20/56

(52) U.S. Cl. CPC G06V 10/803; G06T 7/10; G06V 10/82; G06V 20/56; G06T 2207/20084; G06T 2207/30252; G06T 2207/20072

(57) ABSTRACT

Pose fusion estimation may be achieved via a first and second set of sensors receiving a first and second set of data, passing the first and second set of data through a graph-based neural network to generate a set of geometric features to be passed through a pose fusion network to generate a first and second pose estimate. A second portion of the pose fusion network may receive the set of geometric features and generate a second set of geometric features and the second pose estimate based on the set of geometric features. A first portion of the pose fusion network may receive the first set of data and the second set of geometric features and generate the first pose estimate based on a fusion of the first set of data and the second set of geometric features.

### BACKGROUND

Pose estimation is generally a computer vision task that infers the pose of a person or object in an image or video. Pose estimation may be thought of as a problem of determining the position and orientation of a camera relative to a given person or object. This may be typically done by identifying, locating, and tracking a number of points on a given object or person. For objects, this may be corners or other significant features. And for humans, these points may represent joints such as an elbow or knee. One goal may be to track these points in images and videos.

### BRIEF DESCRIPTION

According to one aspect, a system for pose fusion estimation may include a first set of sensors, a second set of sensors, a processor, and a memory. The first set of sensors may receive a first set of data. The second set of sensors may receive a second set of data. The second set of sensors may be of a different sensor type than the first set of sensors. The memory may store instructions which, when executed by the processor, causes the processor to perform one or more acts, one or more actions, or one or more steps, including passing the first set of data and the second set of data through a graph-based neural network to generate a set of geometric features and passing the set of geometric features and the first set of data through a pose fusion network to generate a first pose estimate associated with the first set of sensors and a second pose estimate associated with the second set of sensors. The pose fusion network may include a first portion and a second portion. The second portion of the pose fusion network may receive the set of geometric features and may generate a second set of geometric features and the second pose estimate based on the set of geometric features. The first portion of the pose fusion network may receive the first set of data and the second set of geometric features and may generate the first pose estimate based on a fusion of the first set of data and the second set of geometric features.

The first set of sensors may include visual sensors or image capture devices. The second set of sensors may include tactile sensors or pressure sensors. The processor may perform semantic segmentation on the first set of data prior to passing the first set of data through the pose fusion network. The processor may pass the first set of data through a convolutional neural network (CNN) prior to passing the first set of data to the pose fusion network. The first portion of the pose fusion network may include one or more rotation layers, one or more translation layers, and one or more confidence layers. The second portion of the pose fusion network may include one or more rotation layers, one or more translation layers, and one or more confidence layers. The processor may generate a first confidence level associated with the first pose estimate and a second confidence level associated with the second pose estimate. The processor may select one of the first pose estimate or the second pose estimate based on the first confidence level and the second confidence level. The system for pose fusion estimation may include one or more vehicle systems implementing an action based on the first pose estimate or the second pose estimate.

According to one aspect, a computer-implemented method for pose fusion estimation may include receiving, via a first set of sensors, a first set of data and receiving, via a second set of sensors, a second set of data. The second set of sensors may be of a different sensor type than the first set of sensors. The computer-implemented method for pose fusion estimation may include passing, via a processor, the first set of data and the second set of data through a graph-based neural network to generate a set of geometric features and passing, via the processor, the set of geometric features and the first set of data through a pose fusion network to generate a first pose estimate associated with the first set of sensors and a second pose estimate associated with the second set of sensors. The pose fusion network may include a first portion and a second portion. The second portion of the pose fusion network may receive the set of geometric features and may generate a second set of geometric features and the second pose estimate based on the set of geometric features. The first portion of the pose fusion network may receive the first set of data and the second set of geometric features and may generate the first pose estimate based on a fusion of the first set of data and the second set of geometric features.

The first set of sensors may include visual sensors or image capture devices and the second set of sensors may include tactile sensors or pressure sensors. The first portion of the pose fusion network may include one or more rotation layers, one or more translation layers, and one or more confidence layers. The second portion of the pose fusion network may include one or more rotation layers, one or more translation layers, and one or more confidence layers.

The computer-implemented method for pose fusion estimation may include performing, via the processor, semantic segmentation on the first set of data prior to passing the first set of data through the pose fusion network, passing, via the processor, the first set of data through a convolutional neural network (CNN) prior to passing the first set of data to the pose fusion network, generating, via the processor, a first confidence level associated with the first pose estimate and a second confidence level associated with the second pose estimate, selecting, via the processor, one of the first pose estimate or the second pose estimate based on the first confidence level and the second confidence level, implementing, via one or more vehicle systems, an action based on the first pose estimate or the second pose estimate.

According to one aspect, a system for pose fusion estimation may include a first set of image sensors, a second set of tactile sensors, a processor, and a memory. The first set of image sensors may receive a first set of data. The second set of tactile sensors may receive a second set of data. The memory may store instructions which, when executed by the processor, causes the processor to perform one or more acts, one or more actions, or one or more steps, including passing the first set of data and the second set of data through a graph-based neural network to generate a set of geometric features and passing the set of geometric features and the first set of data through a pose fusion network to generate a first pose estimate associated with the first set of image sensors and a second pose estimate associated with the second set of tactile sensors. The pose fusion network may include a first portion and a second portion. The second portion of the pose fusion network may receive the set of geometric features and may generate a second set of geometric features and the second pose estimate based on the set of geometric features. The first portion of the pose fusion network may receive the first set of data and the second set of geometric features and may generate the first pose estimate based on a fusion of the first set of data and the second set of geometric features.

### BRIEF DESCRIPTION OF THE DRAWINGS

FIG. 1 is an illustration of an exemplary component diagram of a system for pose fusion estimation, according to one aspect.

FIG. 2 is an illustration of an exemplary network for pose fusion estimation, according to one aspect.

FIG. 3 is an illustration of an exemplary flow diagram of a method for pose fusion estimation, according to one aspect.

FIG. 4 is an illustration of an example computer-readable medium or computer-readable device including processor-executable instructions configured to embody one or more of the provisions set forth herein, according to one aspect.

FIG. 5 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle or robot that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, a tactile sensor system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

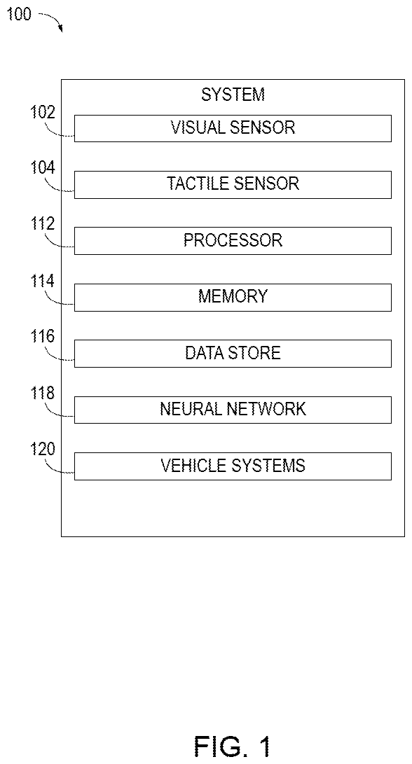

As discussed below, with reference to FIGS. 1-3, a framework that may understand the inherent geometric structure of an object for pose prediction. The framework may connect and interpret the relationship between depth inputs of multiple sources. These inputs may describe the surface geometry based on their position relative to the neighborhood points. In this way, the provided systems, techniques, and framework enable pose prediction or pose estimation to be provided even when either of the sensory input has generally insufficient data when taken alone.

FIG. 1 is an illustration of an exemplary component diagram of a system 100 for pose fusion estimation, according to one aspect. The system 100 for pose fusion estimation may include one or more sets of sensors, such as a first set of sensors 102, a second set of sensors 104, etc. The second set of sensors 104 may be of a different sensor type than the first set of sensors 102. The system 100 for pose fusion estimation may include a processor 112, a memory 114, a data store 116, a neural network 118, and one or more vehicle systems 120 which may include one or more robot systems, robotic arms, robotic fingers, actuators, etc. which may be equipped with one of the sets of sensors (e.g., the second set of tactile sensors). The memory 114 may store instructions which, when executed by the processor 112, causes the processor 112 to perform one or more acts, one or more actions, or one or more steps. According to one aspect, the vehicle systems 120 may include robot systems which include a robot hand gripping an object and equipped with the second set of sensors 104 providing the second set of data pertaining to the gripped object while the first set of sensors 102 provide the first set of data pertaining to an image of the gripped object.

As seen in FIG. 1, the system 100 for pose fusion estimation may include a set of visual sensors, which may be image capture devices, and a set of tactile sensors, which may be pressure sensors, for example. The first set of sensors 102 may receive a first set of data which may include depth data and/or RGB data in the form of RGB images and object-surface point cloud from the depth image of a camera, for example.

The second set of sensors 104 may receive a second set of data which may include tactile data, such as coordinates of the contact points with the tactile sensors or tactile sensor data in the form of an object-surface point cloud or tactile-depth points. According to one aspect, the processor 112 may convert tactile points into depth points. For example, when a robot touches the object, the robot may sense where it is touching the object, and those may be tactile points. In other words, converting tactile points into depth points may mean ensuring that the tactile points (e.g., x, y, z position) are with respect to the camera or image sensors.

### Pre-Processing

The processor 112 may perform semantic segmentation on the first set of data prior to passing the first set of data through the pose fusion network to obtain an object segmented in an image along with the depth data and/or point cloud of the surface of the object.

The processor 112 may pass the first set of data through a convolutional neural network (CNN) prior to passing the first set of data to the pose fusion network to generate image embeddings 203 (e.g., to capture texture of the object), which may be fed to the pose fusion network.

### Graph-Based Neural Network

The processor 112 may pass the first set of data and the second set of data through a graph-based neural network, such as an EdgeConv network, series of EdgeConv networks, a dynamic graph convolutional neural network (CNN), or other graph-based neural network to generate a set of geometric features 205. The graph-based neural network may be part of a pipeline that may meaningfully connect two different types of sensory inputs, such as the vision or visual inputs and tactile inputs from the two different types or sets of sensors.

Explained another way, the graph-based neural network may combine the depth image information from the first set of data and the object surface contact points from the second set of data, which are both in the same frame of reference to the camera or first set of sensors 102. The graph-based neural network may, for example, calculate a number of nearest neighbors and a number of farthest neighbors of each point input to the graph-based neural network. Thereafter, the graph-based neural network may learn the edge weights, which may be a representation of how close respective neighboring points are to each other for a given edge and how farther away are those neighbors to each of them. The output of the graph-based neural network may be features in feature space including geometric features.

### Pose Fusion Network Using Geometry Based Deep Connections

One goal may be to combine the geometric features with image features. In this regard, the processor 112 may pass the set of geometric features 205 and the first set of data (e.g., 203) through a pose fusion network to generate a first pose estimate 213 associated with the first set of sensors 102 and a second pose estimate 215 associated with the second set of sensors 104. The pose fusion network may include a first portion 212 and a second portion 214. The first portion 212 of the pose fusion network may include one or more rotation layers, one or more translation layers, and one or more confidence layers. Similarly, the second portion 214 of the pose fusion network may include one or more rotation layers, one or more translation layers, and one or more confidence layers. The rotation layers may facilitate representation of orientation (e.g., as a quaternion). The translation layers may facilitate representation of position (e.g., X, Y, Z coordinates). The translation layers may facilitate representation of confidence of the corresponding pose estimate.

The second portion 214 of the pose fusion network may receive the set of geometric features 205 and may generate a second set of geometric features (e.g., arrows going up) and the second pose estimate 215 based on the set of geometric features 205.

The first portion 212 of the pose fusion network may receive the first set of data (e.g., this may be received as image embeddings 203 from the CNN 202) and the second set of geometric features and may generate the first pose estimate 213 based on a fusion of the first set of data and the second set of geometric features. In this way, the system 100 for pose fusion estimation may estimate the 6D pose of an object that considers geometric features of an object detected by the first set of sensors 102 and the second set of sensors 104. In other words, the set of geometric features may be in geometric space while the image embedding may be in image space. To combine these features, they may be converted to a common space (e.g., pose space) via the pose fusion network.

The processor 112 may generate a first confidence level associated with the first pose estimate 213 based on one or more of the confidence layers and a second confidence level associated with the second pose estimate 215 based on one or more of the confidence layers.

### Selection Based on Confidence

The processor 112 may select one of the first pose estimate 213 or the second pose estimate 215 based on the first confidence level and the second confidence level (e.g., selecting the higher confidence). As previously discussed, the system 100 for pose fusion estimation may include one or more vehicle systems 120 or one or more robot systems. These systems may implement an action based on the first pose estimate 213, the second pose estimate 215, or the selected pose estimate.

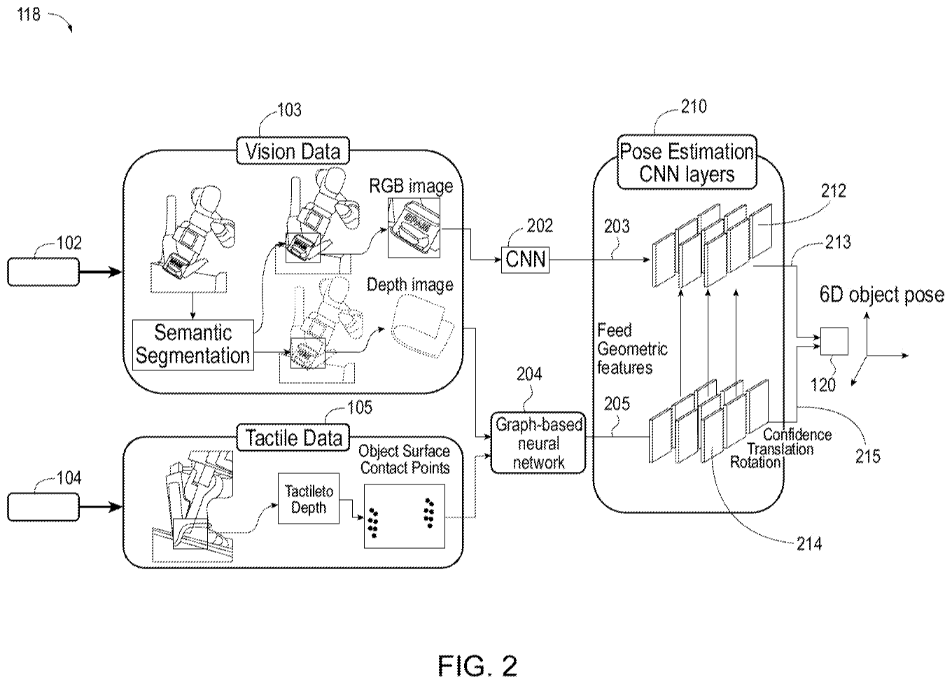

FIG. 2 is an illustration of an exemplary neural network 118 for pose fusion estimation, according to one aspect. The neural network 118 of FIG. 2 may be an architecture which geometrically combines depth and tactile points to estimate the pose of an object.

As seen in FIG. 2, the first set of sensors 102 may receive the first set of data and the second set of sensors 104 may receive the second set of data. The network for pose fusion estimation may include a semantic segmentation portion 103 and the processor 112 may perform semantic segmentation via the semantic segmentation portion 103 on the first set of data prior to passing the first set of data through the pose fusion network. The first set of data may include depth image data and image data.

According to one aspect, the image data may include RGB image data or visual features. The network for pose fusion estimation may include a convolutional neural network (CNN) 202 and the processor 112 may pass the first set of data through the CNN 202 prior to passing the first set of data to the pose fusion network. In other words, the visual features may be passed through a series of CNNs. At each level, the geometric features associated with the object-surface point cloud from the depth image may be fused with the visual features, thereby, accounting for the geometric features of the object.

The second set of data may include a tactile to depth portion 105 which may convert tactile points to object surface contact points from the second set of sensors 104. The network for pose fusion estimation may include a graph-based neural network 204, EdgeConv network, dynamic graph convolutional neural network, or other graph-based neural network and the processor 112 may pass the first set of data and the second set of data through the graph-based neural network 204, dynamic graph convolutional neural network, graph-based neural network to generate a set of geometric features. In this way, the object-surface point clouds from the set of tactile sensors and the image sensors or cameras may be fused using the graph-based neural network. The graph may represent the object-surface point cloud, where each point may be represented by a node in the graph. Each node may be connected to its k nearest and k farthest neighboring nodes by a weighted edge. The weight of an edge may be set to the Euclidean distance between the points in the two nodes the edge is connecting.

These geometric features may be then passed through a graph-based neural network, such as a series of EdgeConv, to estimate the pose of the object. The graph-based neural network 204 may learn the complex geometric features of the object, fusing geometric information from the tactile sensor data and the camera's depth image or learns the relationship between the depth image points from the first set of data ad the tactile points from the second set of data. Further, the graph-based neural network 204 may learn a way between these edges or how close or how far a tactile point may be to a visual point. In this way, the pose may be estimated for each object-surface point with their respective confidences.

One advantage of this approach is that it may leverage the information in edge weights to develop a relation between the complex geometric features. Furthermore, this graph-based neural network approach may connect or form an association or correspondence for the points from the set of tactile sensors and the points from the depth image of the set of image sensors or cameras and this relation may be permutation invariant.

The network for pose fusion estimation may include a pose fusion network 210 and the processor 112 may pass the set of geometric features 205 and the first set of data through a pose fusion network 210 to generate a first pose estimate 213 associated with the first set of sensors 102 and a second pose estimate 215 associated with the second set of sensors 104. The pose fusion network 210 may include a first portion 212 and a second portion 214. The first portion 212 of the pose fusion network 210 may include one or more rotation layers, one or more translation layers, and one or more confidence layers. Similarly, the second portion 214 of the pose fusion network 210 may include one or more rotation layers, one or more translation layers, and one or more confidence layers.

The second portion 214 of the pose fusion network 210 may receive the set of geometric features 205 and may generate a second set of geometric features and the second pose estimate 215 based on the set of geometric features 205. The processor 112 may generate a second confidence level associated with the second pose estimate 215 based on one or more of the confidence layers of the second portion 214 of the pose fusion network 210. The first portion 212 of the pose fusion network 210 may receive the first set of data and the second set of geometric features and may generate the first pose estimate 213 based on a fusion of the first set of data and the second set of geometric features. The processor 112 may generate a first confidence level associated with the first pose estimate 213 based on one or more of the confidence layers of the second portion 214 of the pose fusion network 210.

The processor 112 may select one of the first pose estimate 213 or the second pose estimate 215 based on the first confidence level and the second confidence level.

One benefit of this approach may be that, first the framework uses a graph-based approach to fuse the tactile sensor data and vision sensor data and subsequently learn complex geometric features through a graph-based neural network, such as a series of EdgeConv. Second, the framework fuses the learned geometric features with the RGB features in the object pose space (e.g., within the pose fusion network 210) where the two sources of data may be compatible.

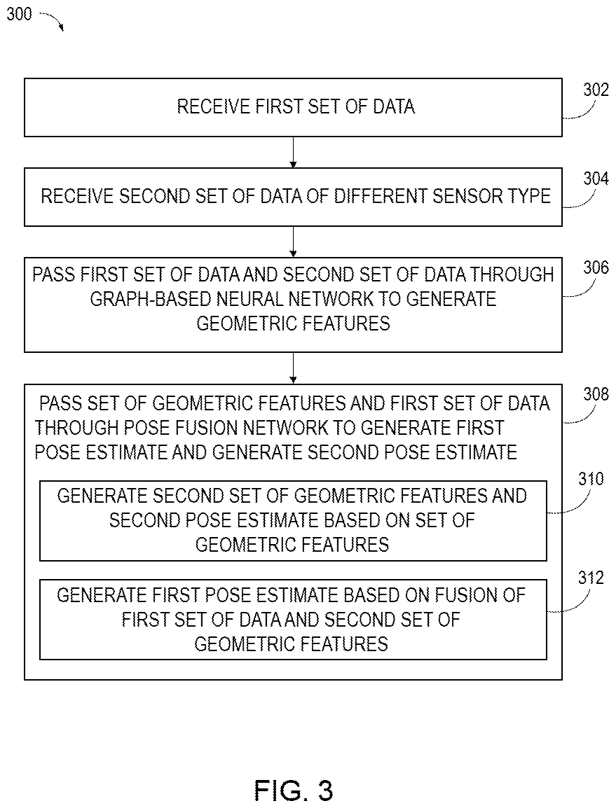

FIG. 3 is an illustration of an exemplary flow diagram of a method for pose fusion estimation, according to one aspect. The method for pose fusion estimation may include receiving 302, via a first set of sensors 102, a first set of data and receiving 304, via a second set of sensors 104, a second set of data. The second set of sensors 104 may be of a different sensor type than the first set of sensors 102. For example, the first type of sensor may be of visual type while the second type of sensor may be of tactile type. The computer-implemented method for pose fusion estimation may include passing 306, via a processor 112, the first set of data and the second set of data through a graph-based neural network, an EdgeConv network, or dynamic graph convolutional neural network (CNN) to generate a set of geometric features 205 and passing 308, via the processor 112, the set of geometric features and the first set of data through a pose fusion network 210 to generate a first pose estimate 213 associated with the first set of sensors 102 and a second pose estimate 215 associated with the second set of sensors 104.

The pose fusion network 210 may include a first portion 212 and a second portion 214. The second portion 214 of the pose fusion network 210 may receive the set of geometric features and may generate 310 a second set of geometric features and the second pose estimate 215 based on the set of geometric features. The first portion 212 of the pose fusion network 210 may receive the first set of data and the second set of geometric features and may generate 312 the first pose estimate 213 based on a fusion of the first set of data and the second set of geometric features.

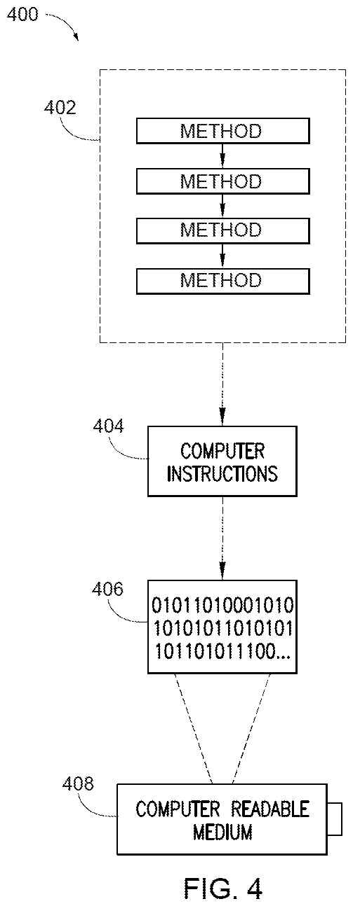

Still another aspect involves a computer-readable medium including processor-executable instructions configured to implement one aspect of the techniques presented herein. An aspect of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This encoded computer-readable data 406, such as binary data including a plurality of zero's and one's as shown in 406, in turn includes a set of processor-executable computer instructions 404 configured to operate according to one or more of the principles set forth herein. In this implementation 400, the processor-executable computer instructions 404 may be configured to perform a method 402, such as the method 300 of FIG. 3. In another aspect, the processor-executable computer instructions 404 may be configured to implement a system, such as the system 100 for pose fusion estimation of FIG. 1 or the neural network 118 of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

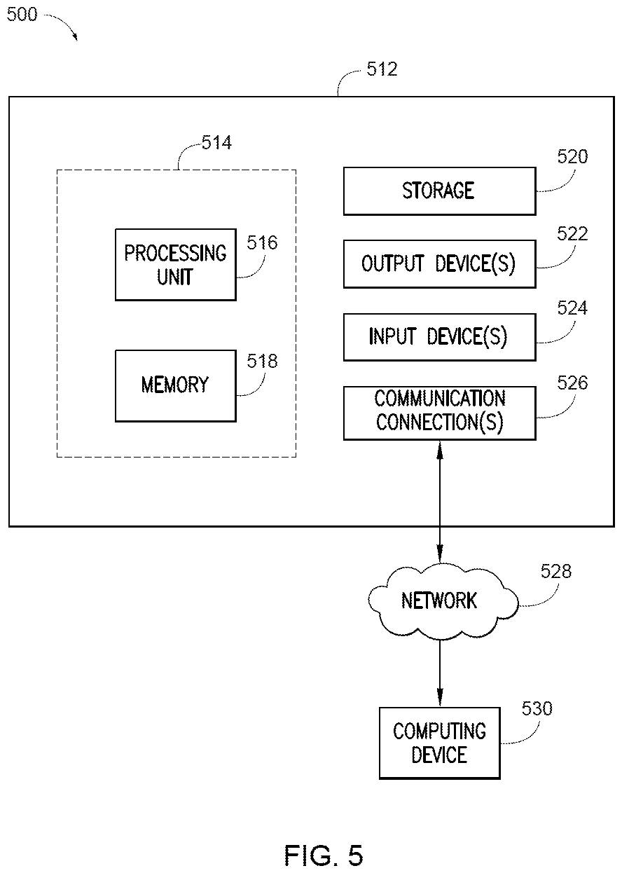

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for pose fusion estimation, comprising:
a first set of sensors receiving a first set of data;
a second set of sensors receiving a second set of data, wherein the second set of sensors is of a different sensor type than the first set of sensors;
a processor; and
a memory storing instructions which, when executed by the processor causes the processor to perform:
passing the first set of data and the second set of data through a graph-based neural network to generate a set of geometric features; and
passing the set of geometric features and the first set of data through a pose fusion network to generate a first pose estimate associated with the first set of sensors and a second pose estimate associated with the second set of sensors,
wherein the pose fusion network includes a first portion and a second portion, wherein the second portion of the pose fusion network receives the set of geometric features and generates a second set of geometric features and the second pose estimate based on the set of geometric features, and wherein the first portion of the pose fusion network receives the first set of data and the second set of geometric features and generates the first pose estimate based on a fusion of the first set of data and the second set of geometric features.

2. The system for pose fusion estimation of claim 1, wherein the first set of sensors include visual sensors or image capture devices.

3. The system for pose fusion estimation of claim 1, wherein the second set of sensors include tactile sensors or pressure sensors.

4. The system for pose fusion estimation of claim 1, wherein the processor performs semantic segmentation on the first set of data prior to passing the first set of data through the pose fusion network.

5. The system for pose fusion estimation of claim 1, wherein the processor passes the first set of data through a convolutional neural network (CNN) prior to passing the first set of data to the pose fusion network.

6. The system for pose fusion estimation of claim 1, wherein the first portion of the pose fusion network includes one or more rotation layers, one or more translation layers, and one or more confidence layers.

7. The system for pose fusion estimation of claim 1, wherein the second portion of the pose fusion network includes one or more rotation layers, one or more translation layers, and one or more confidence layers.

8. The system for pose fusion estimation of claim 1, wherein the processor generates a first confidence level associated with the first pose estimate and wherein the processor generates a second confidence level associated with the second pose estimate.

9. The system for pose fusion estimation of claim 8, wherein the processor selects one of the first pose estimate or the second pose estimate based on the first confidence level and the second confidence level.

10. The system for pose fusion estimation of claim 1, comprising one or more vehicle systems implementing an action based on the first pose estimate or the second pose estimate.

11. A computer-implemented method for pose fusion estimation, comprising:
receiving, via a first set of sensors, a first set of data;
receiving, via a second set of sensors, a second set of data, wherein the second set of sensors is of a different sensor type than the first set of sensors;
passing, via a processor, the first set of data and the second set of data through a graph-based neural network to generate a set of geometric features; and
passing, via the processor, the set of geometric features and the first set of data through a pose fusion network to generate a first pose estimate associated with the first set of sensors and a second pose estimate associated with the second set of sensors,
wherein the pose fusion network includes a first portion and a second portion, wherein the second portion of the pose fusion network receives the set of geometric features and generates a second set of geometric features and the second pose estimate based on the set of geometric features, and wherein the first portion of the pose fusion network receives the first set of data and the second set of geometric features and generates the first pose estimate based on a fusion of the first set of data and the second set of geometric features.

12. The computer-implemented method for pose fusion estimation of claim 11, wherein the first set of sensors include visual sensors or image capture devices and wherein the second set of sensors include tactile sensors or pressure sensors.

13. The computer-implemented method for pose fusion estimation of claim 11, comprising performing, via the processor, semantic segmentation on the first set of data prior to passing the first set of data through the pose fusion network.

14. The computer-implemented method for pose fusion estimation of claim 11, comprising passing, via the processor, the first set of data through a convolutional neural network (CNN) prior to passing the first set of data to the pose fusion network.

15. The computer-implemented method for pose fusion estimation of claim 11, wherein the first portion of the pose fusion network includes one or more rotation layers, one or more translation layers, and one or more confidence layers.

16. The computer-implemented method for pose fusion estimation of claim 11, wherein the second portion of the pose fusion network includes one or more rotation layers, one or more translation layers, and one or more confidence layers.

17. The computer-implemented method for pose fusion estimation of claim 11, comprising generating, via the processor, a first confidence level associated with the first pose estimate and a second confidence level associated with the second pose estimate.

18. The computer-implemented method for pose fusion estimation of claim 17, comprising selecting, via the processor, one of the first pose estimate or the second pose estimate based on the first confidence level and the second confidence level.

19. The computer-implemented method for pose fusion estimation of claim 11, comprising implementing, via one or more vehicle systems, an action based on the first pose estimate or the second pose estimate.

20. A system for pose fusion estimation, comprising:
a first set of image sensors receiving a first set of data;
a second set of tactile sensors receiving a second set of data;
a processor; and
a memory storing instructions which, when executed by the processor causes the processor to perform:
passing the first set of data and the second set of data through a graph-based neural network to generate a set of geometric features; and
passing the set of geometric features and the first set of data through a pose fusion network to generate a first pose estimate associated with the first set of image sensors and a second pose estimate associated with the second set of tactile sensors,
wherein the pose fusion network includes a first portion and a second portion, wherein the second portion of the pose fusion network receives the set of geometric features and generates a second set of geometric features and the second pose estimate based on the set of geometric features, and wherein the first portion of the pose fusion network receives the first set of data and the second set of geometric features and generates the first pose estimate based on a fusion of the first set of data and the second set of geometric features.
